(19) United States
(12) Patent Application Publication
(10) Pub. No.: US 2005/0151664 A1
(43) Pub. Date: Jul. 14, 2005

(54) Cheque please wait or service person summoning device

(76) Inventors: Russell J. Kolish, Hartsdale, NY (US); Jeanne E. Kolish, Hartsdale, NY (US)

Correspondence Address: RUSSELL KOLISH, 39 FIELDSTONE DRIVE, F-2, HARTSDALE, NY, 10530, US

(21) Appl. No.: 10/751,423

(22) Filed: Jan. 6, 2004

(51) Int. Cl. G08B 5/22

(52) U.S. Cl. 340/815.45; 340/286.09

(57) ABSTRACT

The abstract summary of the “Cheque Please Wait or Service Person Summoning Device” is that it is an invention which provides a means to summon a wait or service person in a restaurant, cafe or other public place by lighting up in two different ways, that is lighting up either the red LED (light-emitting diode) or lighting up both the green LED and the white incandescent bulb which lies below the cut out words, ‘Cheque please,’ on one surface of the box at the same time, in order to visually and soundlessly capture their attention. The main characteristics of the invention are that the invention has three different lights and the cut out words, ‘Cheque please,’ which may be illuminated, which individually and in combination, through the manipulation of a switch, provide visual signals to wait or service person(s) that their service(s) are wanted, that is, that his or her or their physical presence is wanted at the location of the person who is displaying the invention (the operator) and/or that a check for goods and services is desired at that location. What is new in the art to which the invention pertains is the unique combinations and uses of elements which comprise the “Cheque Please Wait or Service Person Summoning Device,” the three lights, the switch, the battery, the wiring and the box shaped container, and the cut out words, ‘Cheque please,’ on one surface of the box, and which give the device its essential quality of providing a means to summon service or wait person(s) by visually gaining their attention and also to signal to wait or service person(s) that a check for goods and services is wanted.

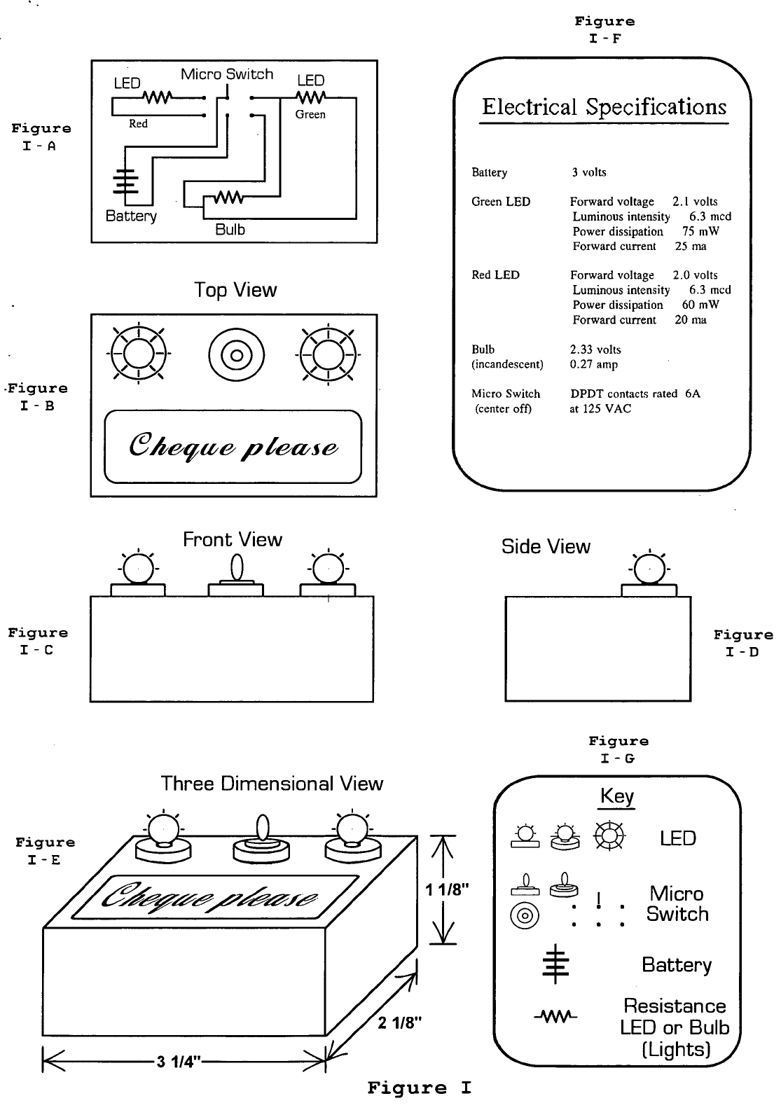

### BACKGROUND OF THE INVENTION

1. Field of the Invention

The technical field of this invention is: The field of endeavor to which this invention pertains is: signaling to service people—the signaling to service persons that their presence is needed and/or that a check for goods and services provided by the establishment is wanted by the individual(s) who have in their possession the “Check Please Wait or Service Person Summoning Device.”

This invention solves problems and has advantages from two points of view, the point of view of the person who displays or uses the invention, the operator who would usually be the customer, too, and the point of view of the wait or service person(s).

This invention solves these previously existing problems:

From the point of view of the user of the invention, the invention solves the following problems: the problem of wasting one's time and emotional resources futilely trying to gain the attention of the wait person by visually tracking their movements(s) and waving one's hand(s) in the air; the problem of loss of focus and concentration required in face to face conversation with business associates, family members or dates (courting) while futilely trying to gain the attention of the wait person by visually tracking their movements(s) and waving one's hand(s) in the air. It is also useful when one is alone and doesn't want to be aggravated by the neck turning and hand waving necessary to gain the attention of the wait person. The problem of abrupt expletives or other aural pollution being spewed into the environment by an aggravated customer is also addressed by the use of this device as the (use of the device) eliminates the customer's frustration when he or she is trying to gain the attention of the wait person by engaging in the above behaviors.

From the point of view of wait or service person(s), the invention solves the following problems: the problem of being unaware that customer(s) at any given table or counter are in need of service. If the “Cheque Please Wait or Service Person Summoning Device” is being used, a wait or service person needs only to scan the room visually to notice a glowing LED lighted at a table and then go to the source of the signal. Also, there are no misinterpretations of customers' signals when they are using the device as there might be if a customer is waving their hand or moving their eyes about. From the wait person's point of view, are these gestures signals for the wait person's attention or are they conversational gestures or are they just mannerisms? The use of the device eliminates the problem of interpretation and enables exact and correct signals between customers and wait persons.

This invention has the following advantages:

From the point of view of the user of the invention, the invention has the following advantages: the use of this invention allows the owner of the device and his/her guest(s) to continue their conversations(s) without the aggravating interruptions required to gain the attention of the wait person. The use of this device allows more freedom from interruption of attention given to one's companion(s) at the location where the device is being used. The device's glowing LEDs (light-emitting diodes—lights on the device) are easily visible across a room and come to the attention of service or wait persons sooner or later with little effort on the part of the owner. The LEDs are of low intensity and the device does not visually annoy nearby patrons. The use of the device also eliminates aural pollution (shouting for the wait person). It is very civilized.

From the point of view of wait or service person(s), the invention has the following advantages: the use of this device enables the wait or service person(s) to give better service, more timely and faster service, to customer(s) who use the device. The use of the device enables the wait or service person(s) to become aware more quickly that they are needed at any table where the device is in use. It enables wait or service person(s) to give their attention more efficiently where it is needed. It enables wait or service person(s) to please their customers with timely attention. It enables exact and correct signaling between customers and wait persons by eliminating false or mistaken interpretations of customers' gestures by wait or service persons.

2. Description of the Related Art

None.

### SUMMARY OF THE INVENTION

The general idea of the claimed invention in summarized form is: a battery-powered device that is used to signal waiters, waitresses and/or other service people that their service(s) are needed, to summon them or call them over to the position where the owner of the device is sitting, that is, the device is used for the purpose of gaining their attention and service and also to display, at a time specified by the flipping of a switch on the device, that a check for goods and services is wanted.

### OBJECT OF THE INVENTION

The object of this invention: this invention shall provide a means, a physical, hand-sized, battery powered, electrically lighted signaling device and its lighted displays, to summon service or wait person(s) and eliminate the frustration, aggravation and feelings of inherent childishness in futilely trying to gain the attention of the wait person by visually tracking their movements(s) and waving one's hand(s) in the air and also to signal to wait or service person(s) that a check for goods and services provided by the establishment is wanted.

The device visually and soundlessly signals to wait or service persons, ‘STOP here; I want your service,’ or, ‘I'm GOing now; please bring my check.’

### A BRIEF DESCRIPTION OF THE DRAWINGS

FIG. I
Explanation of the Figures
FIG. I depicts the following:
1. a circuit diagram (FIG. I-A)which depicts the electrical circuit,
2. drawings of four views (top (FIG. I-B), front (FIG. I-C), side (FIG. I-D) and an additional three-dimensional view with measurements (FIG. I-E) of the “Cheque Please Wait or Service Person Summoning Device”),
3. a listing of the electrical specifications of the electrical components of the “Cheque Please Wait or Service Person Summoning Device,” itemized in the framed section called ‘Electrical Specifications’ (FIG. I-F) which lists the voltage and resistances of the circuit, the types of lights (LEDs and incandescent bulb) and electrical specification of the switch,
4. a ‘Key’ (FIG. I-G) also in a framed section and which depicts and explains the symbols used in the drawings to represent the electrical components.

### DETAILED DESCRIPTION AND EXPLANATION OF THE INVENTION

The “Cheque Please Wait or Service Person Summoning Device” is a hand-sized, battery powered electrical signaling device with lighted LED and incandescent bulb displays and an on-off-on switch housed in a plastic box of six sided polyhedron shape with rectangular sides having dimensions 3 ¼ inches by 1 ⅛ inches by 2 ⅛ inches. The words, ‘Cheque please,’ appear as cut outs on the top surface of the box, that is, the words are physically cut through the top surface of the box allowing them to appear lighted when the incandescent bulb beneath them is switched on. The device contains various electrical elements such as wiring, a battery, a three-position micro switch and two light-emitting diodes (LEDs), a green one and a red one, jutting out from the top of the box, and a small incandescent light bulb, clear in coloring, inside. The box has a removable bottom which enables changing of the battery. The box may also be made from other materials such as exotic woods or may come in other regular geometric shapes such as a tetrahedron, a pyramid; it is not the material or shape of the box that the “Cheque Please Wait or Service Person Summoning Device” comes in that is important but the concept of its purpose. The “Cheque Please Wait or Service Person Summoning Device” is a device whose purpose is to visually and soundlessly summon a wait or service person in a restaurant, cafe or other public place by lighting up in two different ways, that is lighting up either the red LED or lighting up both the green LED and the white incandescent bulb at the same time, in order to visually capture their attention. The ways in which the device lights and the consequent behaviors of the wait or service person(s) are the following: the operator, who wishes to draw the wait person's attention, flips the micro switch to one side which lights up the red light (LED). The wait person notices the red light from across the room and comes over to investigate. Or, at some point when the operator (the customer at the public facility and the person who is displaying the “Cheque Please Wait or Service Person Summoning Device”) wants the wait person to bring the check, he or she flips the switch in the opposite direction which lights up the green light (LED) as well as the internal incandescent light bulb which lies beneath the cut out words ‘Cheque please’ on the top of the “Cheque Please Wait or Service Person Summoning Device.” The cut out words, ‘Cheque please,’ light up with a white glow and make the words readable to the wait person who has come to the table to investigate the other (green colored) light (LED). Now the wait person has been informed that the operator wants his or her check and will then present it. Both this topmost green LED and internal white bulb are switched ‘on’ at the same time when the switch is flipped to the opposite position from the red ‘on’ position. The center most position of the switch is an ‘off’ position. When the switch is in this position, none of the lights are on.

The words ‘Cheque please’ may also be spelled ‘Check please’ on some models and for the French model the words are translated into the French language and may appear as ‘Cheque s'il vous plait.’ Other models following these same basic concepts, described above, are planned for many other non-English languages.

Working model: a full scale working model of the “Cheque Please Wait or Service Person Summoning Device” is available and shall be sent immediately upon your request.

1. A small palm-sized box-shaped battery operated electronic signaling device, of which the non electrical box-shaped part is made of plastic and has the words, ‘cheque please,’ cut through one of the plastic surfaces and of which the electrical parts, consisting of a battery and wires entirely enclosed within the small palm-sized box, a switch and three resistive elements, two light-emitting diodes (leds) and an incandescent bulb, which light up as electrical current from the battery passes through them, and of which the two leds are partially enclosed within and partially mounted on the surface of the small palm-sized box and of which the incandescent bulb is mounted entirely within the box, the field of activity of this signaling device consisting of visually and soundlessly summoning a wait or service person in a restaurant, cafe or other public place by lighting up in two different ways, that is, lighting up either the red led or lighting up both the green led and the white incandescent bulb at the same time, in order to visually capture their attention thus signaling to service persons that their presence is wanted and/or that a check for goods and/or services provided by the establishment is wanted by the individual(s) in possession of the device.
